(19) United States
(12) Patent Application Publication
(10) Pub. No.: US 2014/0338696 A1
(43) Pub. Date: Nov. 20, 2014

(54) Process for dissolving an oxide layer

(71) Applicants: Horst-Otto BERTHOLD, Nurnberg (DE); Alexander Landner, Schaafheim (DE); Andreas LOEB, Niddatal (DE); Hartmut Runge, Alzenau (DE); Dieter STANKE, Schollkrippen (DE)

(72) Inventors: Horst-Otto BERTHOLD, Nurnberg (DE); Alexander Landner, Schaafheim (DE); Andreas LOEB, Niddatal (DE); Hartmut Runge, Alzenau (DE); Dieter STANKE, Schollkrippen (DE)

(21) Appl. No.: 14/200,327

(22) Filed: Mar. 7, 2014

(30) Foreign Application Priority Data
Mar. 8, 2013 (DE) 102013102331.2

(51) Int. Cl. G21F 9/00

(52) U.S. Cl. CPC G21F 9/004
USPC 134/3

(57) ABSTRACT

The invention relates to a process for dissolving a chromium, iron, nickel, zinc and radionuclides containing oxide layer, in particular for breaking down oxide layers deposited on inner surfaces of systems and components of a nuclear power plant, by means of an aqueous decontamination solution containing methanesulfonic acid, which flows in a loop, wherein in regular intervals small amounts of permanganic acid are added, and following reaction of the permanganic acid a second loop is added on in bypass and the dissolved cations and anions are removed by ion-exchange resins from the decontamination solution.

The invention relates to a process for dissolving a chromium, iron, nickel, zinc and radionuclides containing oxide layer, in particular breaking down oxide layers deposited on inner surfaces of systems and components of a nuclear power plant, by means of an aqueous decontamination solution containing an acid.

More particularly, the invention relates to a process for comprehensive breakdown of the radionuclides in the primary system and the auxiliary systems in a nuclear power plant using the existing operating medium and the power plant's operating systems.

During power operation of a nuclear power plant, protective oxide layers are formed at an operating temperature of >180° C. on the internal surfaces of the medium-wetted systems and components. Hereby, radionuclides are incorporated into the oxide matrix. The objective of chemical decontamination processes is to dissolve this oxide layer in order to be able to remove any bound radionuclides. The purpose hereby is to ensure that in the event of an outage period, the radiation exposure of revision personnel is as low as possible, or in the case of demolition of the nuclear reactor the metallic materials of the components can be easily recycled.

Due to their composition and structure (Fe_{0.5}Ni_{1.0}Cr_{1.5}O₄, NiFe₂O₄), the protective oxide layers are considered chemically undissolvable. By an initial oxidative chemical treatment of the oxide structure, the latter can be broken down and the sparingly soluble oxide matrix can be transformed into highly soluble metal oxides. This breaking of the oxide matrix is done by oxidation of trivalent chromium with formation of hexavalent chromium:

Fe_{0.5}Ni_{1.0}Cr_{1.5}O₄/NiFe₂O₄/Fe₃O₄→oxidation→CrO₄²⁻,FeO,NiO,Fe₂O₃ Equation (1)

Globally, the so-called “permanganate peroxidation” according to equation (2) has been established, with the following three oxidation treatments being available:

“NP” oxidation=nitric acid+potassium permanganate (nitric acid, permanganate) (see, for example, EP 0 675 973 B1)

“AP” oxidation=sodium hydroxide+potassium permanganate (alkaline, permanganate)

“HP” oxidation=permanganic acid (see, for example, EP 0 071 336 A1, EP 0 160 831 B1)

Mn-VII+Cr-III→Mn-IV+Cr-VI

2MnO₄¹⁻+Cr₂O₃→2MnO₂+Cr₂O₇ Equation (2)

The manganese ion in permanganate is present in oxidation state 7 and, in accordance with equation (2), is reduced to oxidation state 4, while, at the same time, chromium, present in the trivalent oxidation state, is oxidized to oxidation state 6. According to equation (2), under acidic conditions 2 mol of MnO₄⁻ are needed for the oxidation of 1 mol of Cr₂O₃.

A chemical decontamination of an entire primary system including all activity-carrying auxiliary systems has been carried out only in a few nuclear power plants. In recent years, about 50 different decontamination processes have been developed worldwide. Of all these processes, only those technologies based on a leading pre-oxidation with permanganates (MnO₄⁻) prevailed.

Currently, available chemical decontamination processes are in principle carried out in the following order of processing steps (=decontamination cycle):

Step I: pre-oxidation step
Step II: reduction step
Step III: decontamination step
Step IV: decomposition step
Step V: final cleaning step.

In this case, the sequence of steps I to V is carried out three to six times (three to six decontamination cycles) one after the other.

All processes use permanganate (potassium permanganate, permanganic acid) for pre-oxidation (I) and oxalic acid for reduction (II). Processes differ only in the decontamination step (III). Here, different chemicals and mixtures of chemicals are used.

The previous decontamination processes are based on the concept discussed above. Sparingly soluble protective oxide layers are converted to more easily soluble oxide compounds in the course of a pre-oxidation step and remain on the surface of the system. During pre-oxidation, therefore, activity is not removed from the systems to be decontaminated. So far, a reduction of the dose rate does not take place in this period of decontamination.

Only after the second process step (II) of reduction of permanganates and any manganese dioxide formed by means of oxalic acid and in decontamination step (III) the oxides are dissolved and the dissolved cations/radionuclides are discharged and bound to ion exchange resins.

In all decontamination technologies previously utilized, manganese oxide hydrate [MnO(OH)₂] and manganese dioxide (MnO₂), respectively, form during pre-oxidation (I), as equation (2) illustrates.

Manganese oxide hydrate/manganese dioxide is insoluble and is deposited on the inner surface of the components/systems. Increasing manganese oxide hydrate/manganese dioxide deposition interferes with the desired oxidation of the protective oxide layer. In addition, converted iron and nickel oxides remain undissolved on the surface, so that the barrier layer on the surface increases further.

At the end of the pre-oxidation step the following new chemical compounds are present in the system to be decontaminated, either introduced or formed in step (I):

on the system surface: MnO₂, NiO, FeO, Fe₂O₃, Fe₃O₄
in the pre-oxidation solution: KMnO₄, NaOH or HNO₃, colloidal MnO(OH)₂, CrO₄²⁻ or Cr₂O₇²⁻.

Accordingly, at the end of the pre-oxidation step all metal oxides including radionuclides are still present in the system to be decontaminated. To some extent, manganese oxide hydrate/manganese dioxide that formed was entered in areas of the system that are not flushed and no longer can be discharged/removed in further process steps.

According to the prior art, radioactivity is not reduced in the course of oxidation of the oxide layer, i.e., no decontamination, since essentially no cations are dissolved from the oxide layer which could be removed using a cation exchanger. Rather, the dissolution of the oxide layer is carried out by means of oxalic acid in a second process step, with an upstream reduction step to reduce excess permanganic acid and manganese oxide hydrate. Only after these steps, cations are removed from the cleaning solution (decontamination solution) by ion exchange.

The object of the present invention is to avoid the disadvantages of the prior art, in particular to enable a simplified procedure, wherein the formation of manganese dioxide and metal oxalates is avoided. The formation of CO₂ is excluded. Also, the release of oxide particles is largely avoided.

To solve the problem it is provided in essence that the dissolution of the oxide layer is taking place in a single treatment step using an aqueous decontamination solution flowing in a first loop (K1) with methanesulfonic acid as the acid, that during the entire carrying out of the decontamination methanesulfonic acid remains in the decontamination solution both as a proton donor to adjust the decontamination solution at a pH≦2.5 and as oxide solvent, that the dissolution of chrome-containing oxide layers is done with permanganic acid and that following break-down of the permanganic acid the solution flows, while maintaining the operation of the first loop (K1) via a bypass line in a second loop (K2) through an ion exchanger (IT), in which the present 2- and 3-valent cations and the dissolved radionuclides are fixed, with simultaneous release of methanesulfonic acid.

According to the invention, the objective is essentially achieved in
that oxidation of the oxide layer and its dissolution takes place in a single treatment step using an aqueous decontamination solution,
that methanesulfonic acid is used as decontamination acid,
that said methanesulfonic acid is used both to adjust the pH and for dissolving the metal oxides, and
that the soluble methanesulfonates, after breaking down the permanganic acid, flow via a bypass line through an ion exchanger, in which the dissolved cations and radionuclides are fixed, with simultaneous release of methanesulfonic acid.

According to the invention, it is provided that at the beginning of the procedure the pH is specified by the metered addition of methanesulfonic acid. During the oxidative breakdown of the layer and the process steps carried out in this context, there is no need for any further addition of methanesulfonic acid.

According to the invention, a process is provided to reduce the activity inventory in components and systems, wherein the oxide layers of medium-wetted inner surfaces are removed by means of a decontamination solution. In this context, the decontamination can be carried out with the power plant's own systems without the aid of external decontamination support systems, the activity breakdown can take place without manganese dioxide formation and other cation precipitations and without producing CO₂ and without any release of oxide particles, and, at the same time, the metal oxides are chemically dissolved and fixed as cations/anions together with the manganese and said nuclides (Co-60, Co-58, Mn-54, etc.) on ion exchange resins.

The process can be carried out using the loop or a part of the loop that is present in a nuclear facility such as a nuclear power plant. Insofar, the facilities own, such as the power plant's own systems are used.

In contrast to previous decontamination concepts described above, according to the invention, the chemical conversion of sparingly soluble oxides in highly soluble oxides, the dissolution of the oxides/radionuclides and the discharge and fixing of the dissolved cations to ion exchangers are carried out in a single process step.

Furthermore, and in contrast to the prior art, according to the invention, the permanganic acid used is converted completely to the Mn²⁺ cation. A manganese oxide hydrate/manganese dioxide precipitation does not occur.

By the reaction of manganese VII to manganese II 5 equivalents (electrons) are available for the oxidation of Cr₂O₃. This means that in comparison with the previous decontamination procedures, according to the teaching of the invention the amount of Cr₂O₃ that can be oxidized to chromate/dichromate is almost double.

In previous permanganate-based decontamination concepts, per 100 g of permanganate ions used:
43 g of Cr-III are oxidized to Cr-VI
72.5 g of MnO(OH)₂ precipitate.

In the decontamination concept according to the present invention, per 100 g of permanganate ions used:
73 g of Cr-III are oxidized to Cr-VI
there are no MnO(OH)₂/MnO₂ precipitations.

According to the teaching of the present invention, both the pH as well as the permanganic acid and the proton donor (methanesulfonic acid) are matched according to a fixed logistic scheme such that in the course of carrying out the decontamination:
no manganese dioxide can form
any single oxides (FeO, Fe₂O₃, Fe₃O₄, NiO) formed by the decay of the sparingly soluble spinel/magnetite oxides are simultaneously chemically dissolved
the forming manganese, iron and nickel methanesulfonates are highly soluble
the dissolved cations (Fe³⁺, Fe²⁺, Ni²⁺ and Mn²⁺) and the radionuclides are fixed on ion exchanger.

The formation of manganese dioxide described above following the NP-, AP- or HP-oxidation is avoided according to the invention by using permanganic acid in the acidic range (pH<2.5, preferably pH≦2.2, in particular pH≦2). The Mn²⁺ forming in acidic medium, according to the invention, is removed from the solution already during the “decontamination step” by means of ion exchanger according to equation (3):

a) 6HMnO₄+5Cr₂O₃+2H⁺6Mn²⁺+5Cr₂O₇²⁻+4H₂O Equation (3)

b) Mn²⁺+H₂KIT[Mn²⁺KIT]+2H⁺ Equation (4)

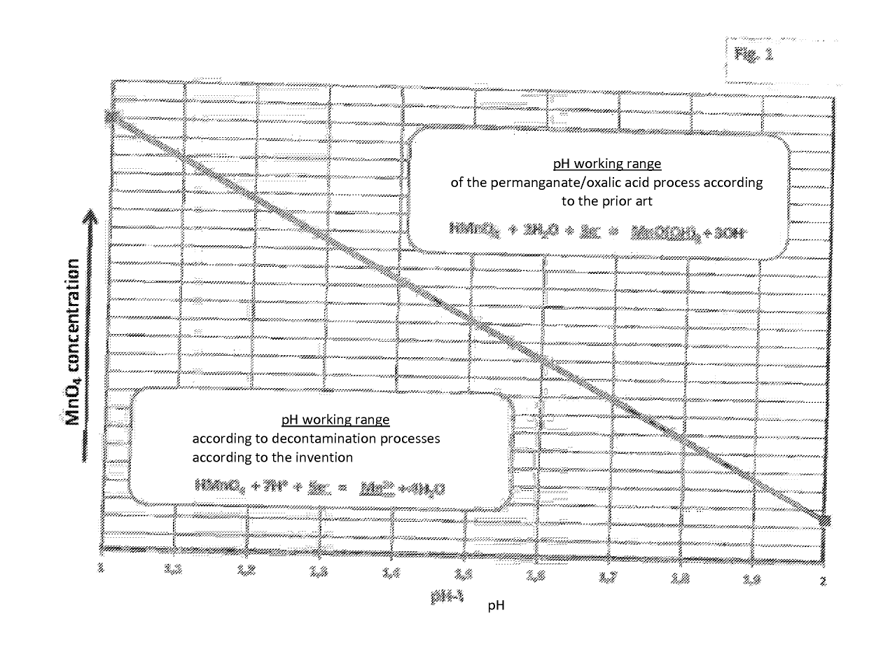

FIG. 1 shows the interaction between pH (=acid concentration) and permanganate content. If the pH is exceeded in the curve shown, manganese dioxide is formed in the oxidation reaction [equations (2) and (3)]. Below the curve, the reaction proceeds with formation of the Mn²⁺ cation [equation (4)].

According to the present invention, the required pH of <2.5, in particular ≦2.2, preferably pH≦2.0 is set by adding methanesulfonic acid. From the acids available, methanesulfonic acid meets the necessary requirements for the decontamination process according to the invention, such as
methanesulfonic acid is stable towards permanganate
it is neither oxidatively degraded nor chemically altered
permanganic acid is not reduced by methane sulfonic acid, there is no formation of manganese dioxide (MnO₂)
metal oxides are dissolved and form highly soluble methanesulfonates
an extra addition of mineral acids (sulfuric acid, nitric acid), organic carboxylic acids (oxalic acid, ascorbic acid, etc.) and complexing agents is not required
the dissolved cations are bound to cation exchange resins, methanesulfonic acid is available again for use in the process
the base material is not impacted.

Due to the properties listed above, at the end of the “oxidative decontamination step” methanesulfonic acid is still available for the next steps.

Any oxides (NiO, Ni₂O₃, FeO) arising in the course of the “oxidative decontamination step” are dissolved by the methanesulfonic acid already during the “HMnO₄ stage”.

According to the present invention, methanesulfonic acid is used for pH adjustment. The amount of methane sulfonic acid that is necessary to avoid the formation of MnO(OH)₂ depends on the permanganate concentration. With increasing permanganate concentration, the pH must be lowered, i.e., a higher acid concentration must be set (FIG. 1).

As a guideline, the following pH values apply:
at 0.1 mol permanganic acid per liter, a pH of about 1
at 0.01 mol permanganate per liter, a pH of about 2

When carrying out the “HMnO₄ stage”, the concentration of free protons (H⁺) is reduced by the formation of metal methanesulfonates. The amount of dissolved Fe, Ni, Zn, Mn cations is therefore included in the calculation of the additional methanesulfonic acid requirements according to the following formulas:

mg CH₃SO₃⁻¹/liter=[mg cation liter]×[cation specific-factor].

According to the present invention, depending on the Fe/Cr/Ni/Zn composition of the protective layer, the amount of individual cations which is released in each respective “HMnO₄ stage” can be calculated precisely in advance as a function of the HMnO₄ used. This is possible because 100% of the amount of HMnO₄ used is converted to Mn²⁺ thereby forming a stoichiometric amount of dichromate. The amount of oxidized Cr-III, in turn, predetermines the amount of the converted Fe/Cr/Ni/Zn oxides and thus the Fe/Ni/Zn/Mn ions forming at the “HMnO₄ stage”.

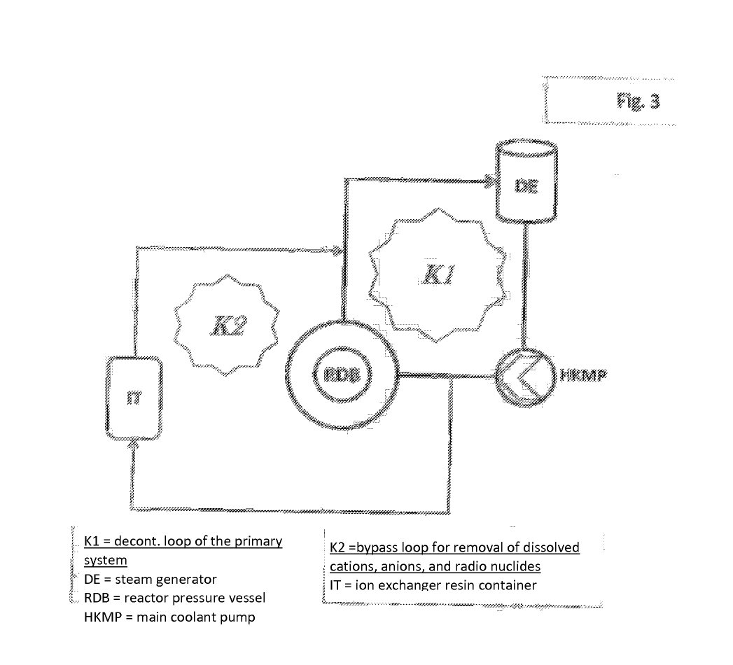

During the oxide conversion at the “HMnO₄ stage” and the simultaneous dissolution of the new oxide structures the system to be contaminated is operated in loop K1 without ion exchanger integration, i.e. without cycle K2. This is illustrated in principle in FIG. 3. During the entire decontamination operation, loop K1 is in operation. Loop K2 is added on to loop K1 in bypass, when the conversion of the amount of HMnO₄ to Mn²⁺ is 100% complete.

To minimize the necessary use of methanesulfonic acid, the “HMnO₄ stage” is carried out preferably at a HMnO₄ concentration of ≦50 ppm of HMnO₄. During the “HMnO₄ stage”, the following chemical partial reactions take place (equations (4) to (7)):

Oxidizing and dissolving Cr₂O₃ incorporated in the protective layer (Fe_{0.5}Ni_{1.0}Cr_{1.5}O₄):

6HMnO₄5Cr₂O₃+12CH₃SO₃H→6[Mn(CH₃SO₃)₂]+5H₂Cr₂O₇+4H₂O Equation (4)

By oxidation of Cr-III oxide under formation of watersoluble dichromate, Ni-II oxide (NiO), Fe-III oxide (Fe₂O₃) and Zn-II oxide (ZnO) are released from the oxide matrix and dissolved by methanesulfonic acid (equation (5) to (7)).

NiO+2CH₃SO₃H→Ni(CH₃SO₃)₂+H₂O Equation (5)

Fe₂O₃+6CH₃SO₃H→2[Fe(CH₃SO₃)₃]+3H₂O Equation (6)

ZnO+2CH₃SO₃H→Zn(CH₃SO₃)₂+H₂O Equation (7)

The above-depicted chemical reactions (equations (4) to (7)) take place simultaneously.

To speed up the “HMnO₄ reaction” and the “methane sulfonic acid reaction” the process temperature is set preferably between 60° C. and 120° C.

According to the present invention, the decontamination preferably takes place in a temperature range of 85° C. to 105° C.

This is illustrated by the diagram in FIG. 3. During the conversion of permanganate to Mn²⁺ the solution is circulated in the system to be decontaminated (loop K1). Following the conversion of permanganate, the solution is passed through ion exchanger IT in the bypass via a cleaning loop K2.

Requirement for the inclusion of an ion exchanger is that the permanganate has completely or substantially converted to Mn²⁺ and the solution is free of MnO₄⁻ ions (reference value <2 ppm of MnO₄).

During the operation of the ion exchanger IT, the di- and trivalent cations (Mn-II, Fe-II, Fe-III, Zn-II and Ni-II) and radionuclides (Co-58, Co-60, Mn-54, etc.) are removed from the solution. At the same time, methanesulfonic acid is released and is again available for use in the process. See equations (8) to (11).

### Release of Methane Sulfonic

Mn(CH₃SO₄)₂+H₂KIT→2CH₃SO₄H+[Mn²⁺-KIT] Equations (8)

Ni(CH₃SO₄)₂+H₂KIT→2CH₃SO₄H+[Ni²⁺-KIT] Equations (9)

Fe(CH₃SO₄)₂+H₂KIT→2CH₃SO₄H+[Fe²⁺-KIT] Equations (10)

2Fe(CH₃SO₄)₃+3H₂KIT→6CH₃SO₄H+[Fe³⁺-KIT] Equations (11)

The ion exchanger IT is operated at a process temperature of ≦100° C.

The operation of the ion exchanger IT continues in bypass until all dissolved cations, anions and radionuclides are fixed on the ion exchange resin.

According to the present invention, following ion exchanger cleaning, bypass loop K2 will be closed and more permanganic acid will be added into loop K1. The process steps described above are repeated until no further discharge of activity from the system K1 to be decontaminated occurs.

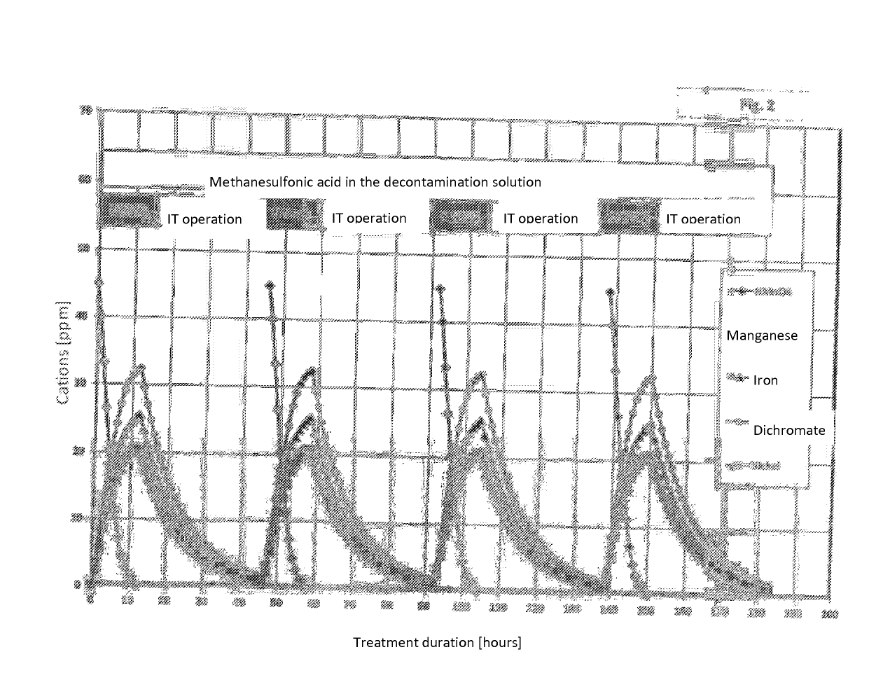

FIG. 2 shows the two stages of the decontamination process, in which the individual phases are defined as follows:
HMnO₄ stage=breaking up and dissolving the oxide matrix, loop operation K1 methanesulfonic+permanganic acid
IT operation=fixing of dissolved cations and radionuclides on to ion-exchange resins
   loop operation K1+parallel loop
   operation K2
   methanesulfonic acid/methane sulfonates

FIG. 2 shows an example of the courses of the cation concentrations at a four-time HMnO₄ dosing as part of a PWR primary system decontamination.

According to the prior art, typically following pre-oxidation excess permanganate is reduced with oxalic acid (step II) and then the decontamination step (step III) is initiated by the addition of further decontamination chemicals.

In these conventional processes, at the time of reduction (step II) all components of the pre-oxidation step (residual permanganate, colloidal MnO(OH)₂, chromate and nickel permanganate) are still in the solution, and all converted metal oxides are on the system or component surface.

Since the metal ion are present in part in dissolved form (MnO₄⁻, CrO₄²⁻) as well as highly soluble metal oxides (NiO, FeO, MnO₂/MnO(OH)₂), already high cation solution concentrations occur in the course of the second process step of reduction (step II).

At the same time, large amounts of CO₂ form by the reduction of permanganate, chromate and manganese dioxide with oxalic acid (see equations (12-14)). This CO₂ formation that takes place on the surface, leads to a mobilization of oxide particles, which then settle in zones of low flow of the system increasing the dose rate in those locations.

2HMnO₄+7H₂C₂O₄→2MnC₂O₄+10CO₂+8H₂O Equation (12)

MnO₂+2H₂C₂O₄→MnC₂O₄+2CO₂+2H₂O Equation (13)

Cr₂O₇²⁻+3H₂C₂O₄+8(H₃O)⁺→2Cr³⁺+6CO₂+15H₂O Equation (14)

With the present invention, the CO₂ formation described above and release of oxide particles do not occur. The oxalate compounds, which are formed from divalent cations and the reducing agent “oxalic acid” have only limited solubility in water. Depending on the process temperature, the solubility of the divalent cations is at:

| | 50° C. | 80° C. | Unit |
|---|---|---|---|
| NiC₂O₄ | about 3 | about 6 | mg Ni-II/liter |
| FeC₂O₄ | about 15 | about 45 | mg Fe-II/liter |
| MnC₂O₄ | about 120 | about 170 | mg Mn-II/liter |

When using previous decontamination processes, in primary system decontamination, mathematically, large cation quantities are released per decontamination cycle. Already in the reduction step, this leads to oxalate precipitations on the inner surfaces of the systems.

The protective oxide layers of a primary system of a pressurized-water nuclear power plant usually result in total in an oxide inventory of 1,900 kg to 2400 kg [Fe, Cr, Ni oxide].

In the decontamination of a primary system of a pressurized water reactor therefore the following maximum cation release can be expected:
Chrome→70 to 80 kg of Cr
Nickel→100 to 120 kg of Ni
Iron→190 to 210 kg of Fe

In the primary system decontamination typically 3 decontamination cycles are carried out. At a total volume of about 600 m³ and a uniform distribution of the cations over 3 cycles, the following concentrations of divalent cations can be expected per cycle:
Nickel→67 ppm of Ni
Iron→117 ppm of Fe

This rough estimate indicates that in all previous decontamination processes that use oxalic acid for reduction and/or decontamination, Fe²⁺ and Ni²⁺ oxalate formation cannot be avoided.

If, as described above, after completion of a decontamination cycle residual oxalate still remains in the system, more permanganate has to be used in the subsequent cycle, as equations (15), (16) show:

3NiC₂O₄+2HMnO₄+H₂O3NiO+2MnO(OH)₂+6CO₂ Equation (15)

3FeC₂O₄+2HMnO₄+H₂O3FeO+2MnO(OH)₂+6CO₂ Equation (16)

Without improving the decontamination result, this leads to a higher permanganate requirement, and as a result, to an increased MnO(OH)₂ deposition on the surfaces and ultimately, to a higher accumulation of the radioactive waste. Additionally, more cations enter the subsequent cycle, the risk of another oxalate formation increases, and the accumulation of ion exchange resins is further increased.

Already dissolved radionuclides (Co-58, Co-60, Mn-54) are incorporated in the oxalate layer. This leads to a re-contamination in the systems.

As already described above, according to the present invention, in the oxidative “HMnO₄ stage” of the decontamination all released cations (Ni-II, Mn-II, Fe-II, Fe-III, Zn-II), and the dichromate are dissolved and the fixation of cations and anions is done by switching the bypass (loop K2) promptly to ion exchange resins.

Each nuclear power plant [PWR, BWR, etc.] has its own specific oxide structure, oxide composition, dissolution characteristics of the oxides, and oxide/activity inventory. In pre-planning of a decontamination only assumptions can be made. Only in the course of the decontamination it will be found out, whether the assumptions made previously were correct.

A decontamination concept must therefore be able to adapt to the respective changes when executed.

With the present invention, any conceivable new requirement can be addressed specifically. The detailed steps delineated above can be repeated any number of times depending on the type and quantity of the oxide/activity inventory present in the system.

Compared with previous processes techniques, a decontamination according to the present invention requires a very low concentration of chemicals. The required quantities of chemicals can therefore be metered with metering systems existing in nuclear power plants (NPPs) and the resulting cations can be removed by means of an NPP's own cleaning systems (ion exchanger). There is no need to install large external decontamination facilities.

By controlling the entire process by the power plant's control room, the process parameters can quickly be adjusted to any new requirements (metering of chemicals, chemical concentrations, process temperature, timing of IT exchanger integration, step sequences, etc.).

The process variations can be carried out, if necessary, until the desired discharge of activity or the desired dose rate reduction is achieved.

Methanesulfonic acid present in the solution remains in solution during execution of all process steps. Its concentration will not be changed. Only at the end of the entire decontamination process, methanesulfonic acid will be bound to ion exchange resins in the course of final cleaning.

Further details, advantages and features of the invention will be apparent not only from the claims—per se and/or in combination—but also from FIGS. 1 to 3 both already described above and described additionally below, which are self-explanatory.

In the figures:

FIG. 1 shows the working pH range of the present invention compared to the prior art,

FIG. 2 shows the change in permanganic acid concentration and cation and dichromic acid concentration as a function of the duration of the process,

FIG. 3 shows the schematic diagram of the decontamination loop (K1) and the IT cleaning loop (K2)

The diagram in FIG. 1 illustrates that a pH, as a function of permanganic acid concentration, falling below the oblique straight line shown in FIG. 1, ensures that manganese dioxide cannot form. According to the prior art, the process is carried out at a pH and a permanganic acid concentration which is above the straight line. Due to this, manganese dioxide forms. Here, the straight line is determined by equations (2) and (3).

FIG. 2 shows, in principle, the decontamination according to the invention. During all stages of decontamination the decontamination solution contains methanesulfonic acid to ensure a pH of ≦2.5. In the process step “HMnO₄ stage”, permanganic acid is added to the solution to convert the insoluble Fe, CrNi oxide composite in highly soluble metal oxides, to dissolve the metal oxides at the same time and to form highly soluble methane sulfonates. Cr-III oxide is oxidized to Cr-VI and exists in the solution as dichromic acid. After permanganate has reacted completely or substantially completely with formation of Mn²⁺, and the solution is substantially free of MnO₄⁻ ions, in process step “IT operation” the solution flows via a bypass through ion exchanger IT (loop K2), where the dissolved cations and radionuclides are fixed. During IT operation methanesulfonic acid is released and is again available for the process.

Then, again, permanganic acid is added to the solution that no longer flows through the cation exchanger, according to the Cr⁻³ to be oxidized in the Fe,CrNi oxide composite.

In the process step “HMnO₄ stage” a chemical conversion of the sparingly soluble Fe, Cr, Ni structure to more soluble oxides by means of permanganic acid takes place. Converted oxide formations are dissolved with methanesulfonic acid. Technically, this process is carried out in a methanesulfonic acid/permanganic acid solution in loop operation (loop K1) (FIG. 3). Loop operation K1 is maintained until permanganic acid is consumed completely and has been converted to Mn²⁺. Usually the conversion of permanganic acid to Mn²⁺ takes 2 to 4 hours, when at the beginning of the process the permanganic acid concentration has been adjusted in the range between 30 and 50 ppm. The conversion of the oxide structure and dissolution of the converted oxides takes place simultaneously. The final products of the dissolution process are metal salts of methanesulfonic acid. Following completion of the “HMnO₄ stage”, the “IT stage” begins. Hereby, the metal cations which are present methylsulfonates and nuclides are passed in bypass (loop K2) through ion exchange resins and fixed there. During the “IT stage” both loops K1 and K2 are in operation. In the exchanger process, methanesulfonic acid is released and is again available for the decontamination solution.

1. A process for dissolving a chromium, iron, nickel, zinc and radionuclides containing oxide layer, in particular for breaking down oxide layers deposited on inner surfaces of systems and components of a nuclear power plant, by means of an aqueous decontamination solution containing an acid,
characterized in that
dissolving of the oxide layer takes place in a single treatment step with the aid of an aqueous decontamination solution flowing in a first loop (K1) with methanesulfonic acid as the acid, such that during the entire carrying out of the decontamination methanesulfonic acid remains in the decontamination solution both as a proton donor to adjust the decontamination solution at a pH≦2.5 and as oxide solvent, that the dissolution of chrome-containing oxide layers is done with permanganic acid and that following break-down of the permanganic acid the solution flows, while maintaining the operation of the first loop (K1) via a bypass line in a second loop (K2) through an ion exchanger (IT), in which the present 2- and 3-valent cations and the dissolved radionuclides are fixed, with simultaneous release of methanesulfonic acid.

2. The process according to claim 1,
characterized in that
in the decontamination solution, a concentration of methanesulfonic acid ≦3,500 ppm is set, preferably 500 to 1000 ppm.

3. The process according to claim 1,
characterized in that
in the oxidation stage of the decontamination process, during which the decontamination solution flows into the first loop (K1), the permanganic acid is set to a maximum concentration of 200 ppm, preferably 50 ppm.

4. The process according to claim 1,
characterized in that
the thickness of the oxide layer to be broken down is controlled by the amount of permanganic acid used.

5. The process according to claim 1,
characterized in that
all stages of decontamination are carried out at a temperature between 60° C. and 120° C., more preferably between 85° C. and 105° C.

6. The process according to claim 1,
characterized in that
during flowing of the decontamination solution through the ion exchange resins in the second loop (K2) said methanesulfonic acid is regenerated by removing the Mn-II/Fe-II/Fe-III/Ni-II ions by means of said ion exchange resins.

7. The process according to claim 1,
characterized in that
the oxide layer deposited on the inner surfaces of a coolant loop of a nuclear power plant or its components is oxidized and dissolved by the decontamination solution containing permanganic acid and methanesulfonic acid recirculating in a first loop (K1) so that after complete consumption of said permanganic acid, in further recirculating operation the decontamination solution is recirculated in a second loop (K2) via a bypass through an ion exchanger to bind Fe, Ni, Zn, Mn cations and radionuclides present in the solution so that afterwards said methanesulfonic acid solution is again supplied with permanganic acid so that prior process steps (HMnO₄ stage, IT stage) are repeated to an extent until no more discharge of activity (radionuclide release) from the system to be decontaminated (loop K1) is detectable.

8. The process according to claim 1,
characterized in that
at the beginning of breaking down the oxide layer the pH is set by means of methanesulfonic acid and that during breaking down the oxide layer and carrying out further process steps a further addition of methanesulfonic acid is stopped.

9. The process according to claim 1,
characterized in that
the pH is set by means of methanesulfonic acid to a value <2.5, preferably <2.2, in particular ≦2.0.

10. The process according to claim 1,
characterized in that
a loop or a partial loop thereof of a nuclear installation, in particular a coolant loop or part thereof is used as the first loop (K1).
